(19) United States
(12) Patent Application Publication
(10) Pub. No.: US 2024/0385405 A1
(43) Pub. Date: Nov. 21, 2024

(54) FIBER PEDESTAL WITH MULTIPLE CONFIGURATIONS

(71) Applicant: viaPhoton, Inc., Aurora, IL (US)

(72) Inventor: Walter Mark HENDRIX, Dallas, TX (US)

(21) Appl. No.: 18/665,051

(22) Filed: May 15, 2024

Related U.S. Application Data
(60) Provisional application No. 63/466,562, filed on May 15, 2023.

(51) Int. Cl. G02B 6/44

(52) U.S. Cl. CPC G02B 6/4452; G02B 6/4457

(57) ABSTRACT

A fiber pedestal comprises a base, a cover, and a distribution box. The base, the cover, and the distribution box structured to form first configuration and a second configuration. The first configuration has a first volume and corresponds to an unassembled state of the fiber pedestal. The second configuration has a second volume that is larger than the first volume and corresponds to an assembled state of the fiber pedestal.

### CROSS-REFERENCE TO RELATED APPLICATIONS

This application claims the benefit of U.S. Provisional Application Ser. No. 63/466,562, filed May 15, 2023, which is hereby incorporated by reference for all purposes.

### BACKGROUND

Pedestal-style electronics enclosures are used in telecommunications systems for housing splices or terminal connections between service wires, distribution wires, and buried cables. These enclosures, also used for cable television, fiber optics, and power distribution, supports, and organizes the cabling and various connections. Given their outdoor location, pedestal enclosures must be weather-tight to protect electronic connections from environmental conditions such as wind, rain, snow, and flooding. Additionally, pedestal enclosures must be secure to prevent unauthorized access and durable enough to withstand outdoor wear-and-tear.

Typically, pedestal enclosures consist of a base section and a cover that are fastened or locked together. However, many traditional pedestal enclosures are bulky and cumbersome, leading to significant storage and shipping challenges. The bulkiness of these units results in inefficient use of space, higher shipping costs, and logistical difficulties.

### SUMMARY

One or more aspects of the invention provide for a fiber pedestal that comprises a base, a cover, and a distribution box. The base, the cover, and the distribution box structured to form first configuration and a second configuration, The first configuration has a first volume and corresponds to an unassembled state of the fiber pedestal. The second configuration has a second volume that is larger than the first volume and corresponds to an assembled state of the fiber pedestal.

Other aspects of the one or more embodiments will be apparent from the following description and the appended claims.

### BRIEF DESCRIPTION OF DRAWINGS

FIG. 1 shows an exploded view of a fiber pedestal according to illustrative embodiments.

FIG. 2A shows the pedestal in a first configuration according to illustrative embodiments.

FIG. 2B shows the pedestal in a second configuration according to illustrative embodiments.

FIGS. 3A and 3B show further details of the first configuration according to illustrative embodiments.

FIGS. 4A and 4B show further details of the second configuration according to illustrative embodiments.

FIGS. 5A and 5B show a volumetric comparison of the first configuration and the second configuration according to illustrative embodiments.

FIGS. 6A and 6B show a splice side of the distribution box according to illustrative embodiments.

FIGS. 7A and 7B show a drop side of the distribution box according to illustrative embodiments.

Like elements in the various figures are denoted by like reference numerals for consistency.

### DETAILED DESCRIPTION

In general, embodiments are directed to a fiber optic pedestal enclosure, optimized for ease of shipping, assembly, and functional deployment. This A fiber pedestal comprises a base, a cover, and a distribution box. The base, the cover, and the distribution box structured to form first configuration and a second configuration, The first configuration has a first volume and corresponds to an unassembled state of the fiber pedestal. The second configuration has a second volume that is larger than the first volume and corresponds to an assembled state of the fiber pedestal.

The pedestal is designed for efficient shipping, coming unassembled in a nested state that allows for a significantly reduced package size compared to the assembled state. The assembly process is simplified by pre-installed fasteners that enables a faster deployment in the field. The pedestal may include modular components such as a trunk cable entry, spice compartment, and drop fiber cable management, which facilitate accessibility and maintenance.

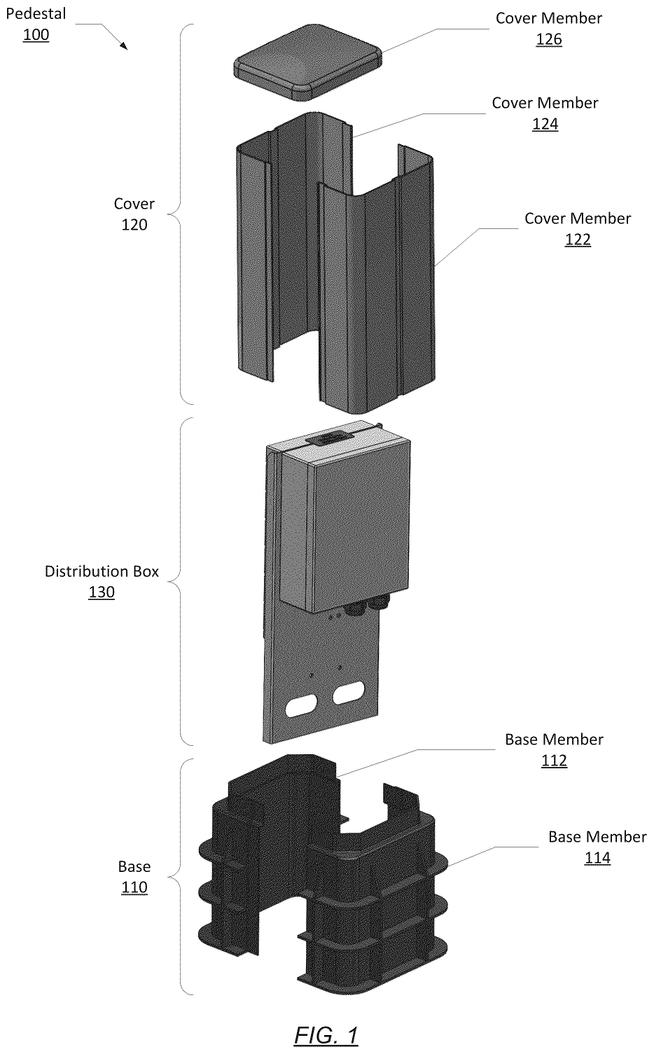

Turning to FIG. 1, the pedestal (100) is illustrated in an exploded view. the pedestal (100) is an outdoor enclosure structured to distribute cables, including optical fibers, from trunk lines to multiple endpoints. For example, the multiple endpoints may be residential homes, offices, multi-family residences, etc. The pedestal (100) includes the base (110), the cover (120), the distribution box (130).

The base (110) supports the cover (120) and the distribution box (130), providing foundational support and housing the lower sections of the fiber and trunk cables. The base is typically made from a durable material such as polymer or a reinforced composite that is capable of withstanding environmental stressors such as temperature variations, moisture, and mechanical impacts. The base (110) may be designed to be partially buried or anchored to ensure the stability of the entire assembly.

The base (110) is formed from the base member (112) and the base member (114). Each base member is designed to interlock with the other, creating a stable foundation for the pedestal (100). In one embodiment, the base member (112) and the base member (114) are structurally the same. One or more of the base members may include mounting points for the distribution box (110). One or more of the base members may include features such as cable entry points and strain relief mechanisms to manage and protect the incoming trunk cables and drop fibers.

In some embodiments, the base member (112) and the base member (114) may be substantially identical. For example, the base member (112) and the base member (114) may be duplicates of a same part.

The cover (120) fits within the base (110) atop the distribution box (130). The cover (120) is designed to protect the internal components from environmental factors such as moisture, dust, and physical damage. The cover (120), which encapsulates the internal components of the pedestal, form a protective enclosure around the pedestal's internal components. In one embodiment, the cover (120) after assembly slides over the distribution box (130) to secure to an exterior of the base (110).

The cover (120) is formed from the cover member (122), the cover member (124), and the cover member (126). These members are designed to fit together, with cover member (122) and cover member (124) wrapping around the majority of the pedestal's body, cover member (126) acts as a top cap, sealing the enclosure from environmental elements such as rain or dust. Each cover member is constructed from materials such as UV-resistant plastics or composites, which provide durability and resistance against environmental damage.

In some embodiments, the cover member (122) and the cover member (124) may be substantially identical. For example, the base member (112) and the base member (114) may be duplicates of a same part.

The distribution box (130) fits within the cover (120) and may be attached to one or more of base member (112), base member (114) and/or cover member (124). the distribution box (130) houses the connections and elements for the operation of fiber optic systems. In one embodiment, the distribution box (130) is structured to receive and distribute cables, which may include fiber optic cables. The distribution box (130) organizes and protects the fiber optic connections, and may include features such as splice compartments, SC adapter compartments, and management systems for drop fibers.

The distribution box (130) box may be made from metal or a robust composite to shield sensitive electronic components from electromagnetic interference and physical damage. The distribution box (130) may include features such as mounting racks or frames for holding fiber optic cables, splices, and/or adapters.

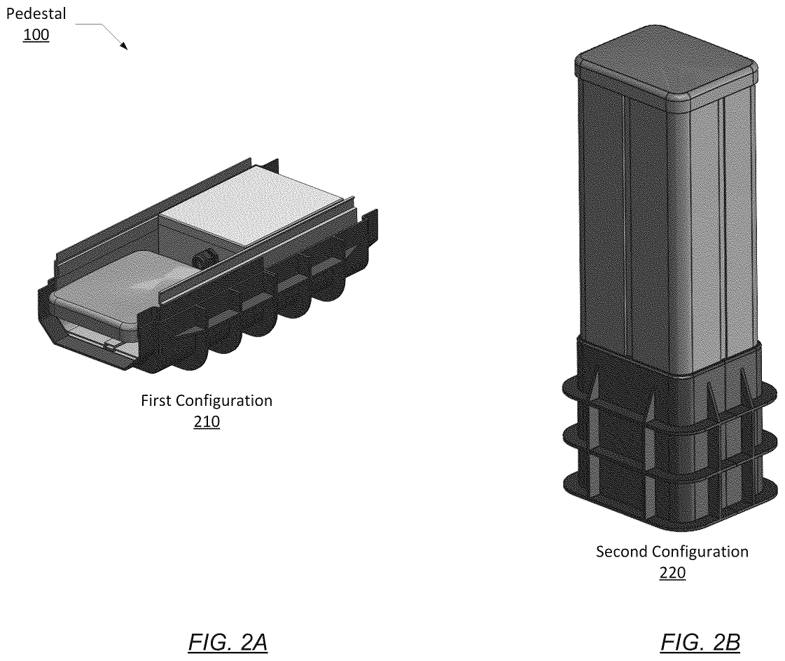

FIG. 2A shows the pedestal (100) is in a first configuration (210). the first configuration (210) shows the pedestal (100) in unassembled state, optimized for packaging and/or shipping, The first configuration (102) has a volume that is less than the volume of the second configuration (220) of FIG. 2B, which depicts the pedestal (100) in an assembled state for deployment in the field.

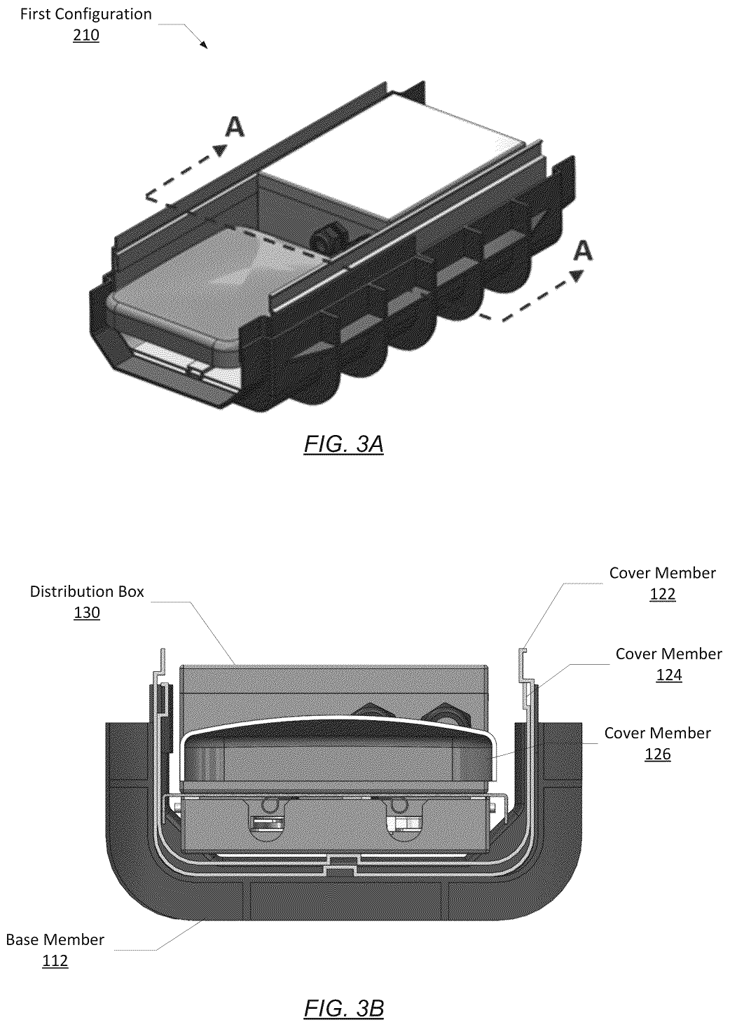

FIGS. 3A and 3B show further details of the pedestal (100) in the first configuration (210). More specifically, FIGS. 3A and 3B illustrate the components base member (112), distribution box (130), cover member (122), cover member (124), and cover member (126) in a compact nested state according to the first configuration (210).

In the nested arrangement of first configuration (210), the base member (112, 114) cradles the other components to optimize space for shipping and storage. The cover members (122, 124) are nested within the base members (112, 114). In the nested configuration, the distribution box (130) is positioned centrally and securely within the base members (112, 114) and cover members (122, 124), enclosing it within the base member. The top cover member (126) is placed adjacent the distribution box (130) and within the cover members (122, 124).

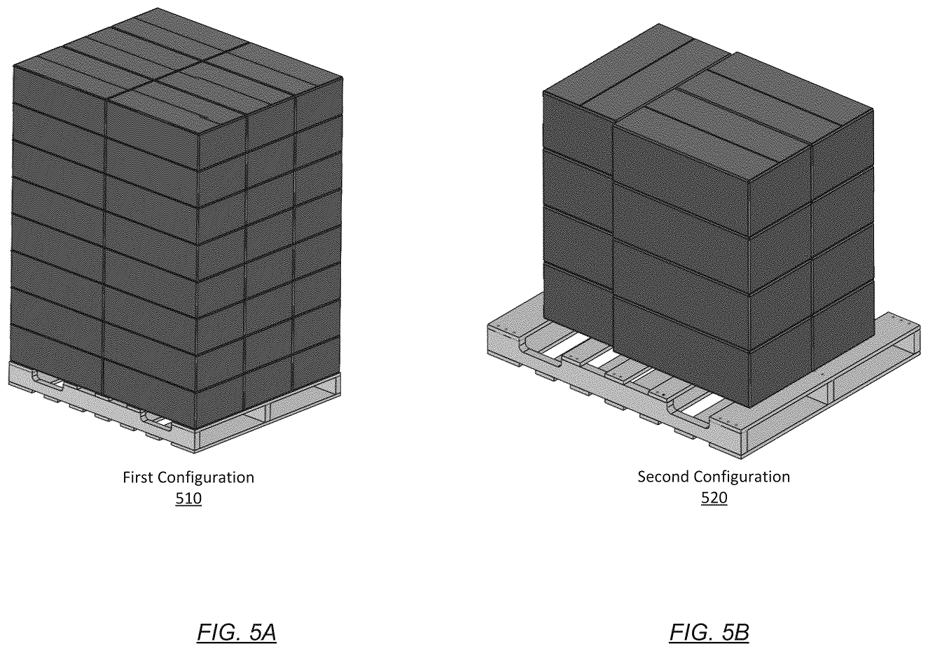

In the nested arrangement of first configuration (210), the base member (112, 114) acts as a cradle, centrally housing the cover members (122, 124) and distribution box (130). This nested arrangement minimizing the overall packaging size and optimizing the number of units that can be shipped per pallet, as shown in FIG. 5.

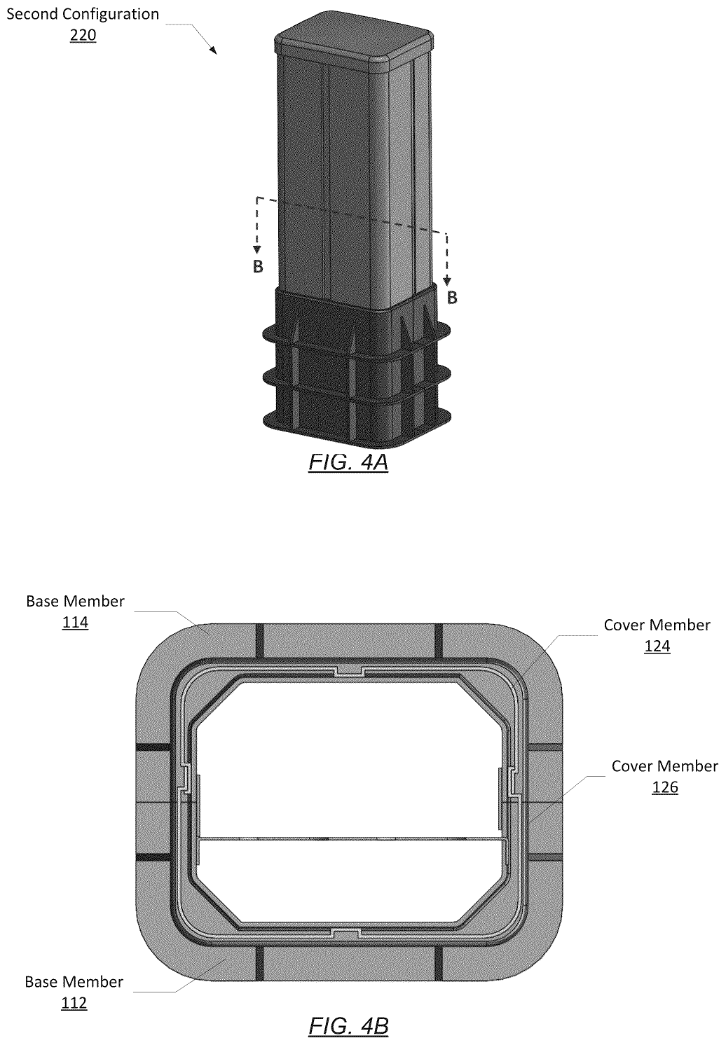

FIGS. 4A and 4B show further details of the pedestal (100) in the second configuration (220). More specifically, FIGS. 4A and 4B illustrate the components base members (112, 114), cover members (122, 124) in an assembled, operational state, according to the second configuration (220).

In the second configuration (220), base member (112) and base member (114) are interlocked to form the lower support structure, with base member (114) on top of base member 112. cover members (122) and (124) are vertically oriented, enclosing the sides of the pedestal and aligning with the base members. cover member (126) sits on top, sealing the enclosure.

FIGS. 5A and 5B show a comparison of space-saving advantages of the fiber pedestal when packaged in the first configuration versus the second configuration.

In the first configuration (510), components of the fiber pedestal are disassembled and nested within each other to minimize the overall volume, such as in first configuration (210). The nested arrangement allows multiple pedestals to be stacked compactly on a single pallet, maximizing the use of available space. the first configuration (510) may be particularly advantageous for transportation and storage, due to reduced shipping costs and warehouse space requirements. For example, a pallet loaded with pedestals in the first configuration might contain up to 48 units, compared to the second configuration.

The second configuration (520) represents the pedestal in a partially and/or fully assembled state, which occupies a larger volume compared to the nested state of the first configuration (510). When packed on a pallet, fewer assembled pedestals can be stacked due to their increased volume. For example, a pallet loaded with pedestals in the second configuration might contain only 12 units due to the larger partially and/or fully assembled size.

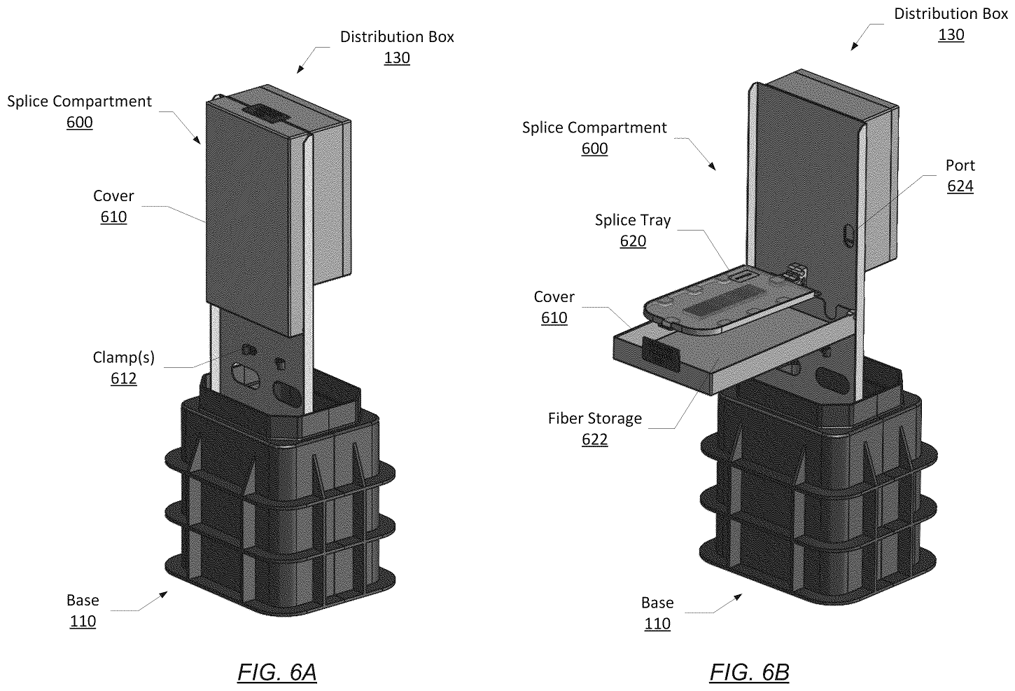

FIGS. 6A and 6B illustrate a splice side of the distribution box (130) when the pedestal (100) is in the second configuration (220). the distribution box (130) is shown with a cover (610) shown in both a closed configuration (FIG. 6A) and an open configuration (FIG. 6B).

The splice compartment (600) is a designated area within the dis distribution box (130) where fiber splices are managed. The splice compartment (600) is equipped with a splice tray (620) and fiber storage (622) to facilitate the organization and protection of spliced fibers.

The cover (610) is designed to protect the internal components of the distribution box from environmental factors such as dust, moisture, and physical damage. The cover (610) is a removable or hinged panel that can be securely closed to seal the splice compartment or opened to provide access for maintenance and installation. The cover (610) may include Fiber Storage (622) that is designed to accommodate excess fiber length and manage slack. A port (624), sometimes called a “mousehole” or “pass-through”, may be provided to allow fibers to pass from the splice side to the drop side of the distribution box (130).

Clamp(s) (612) are provided to secure the trunk cables that enter the (130), preventing undue stress on fiber connections, which could otherwise cause damage or connection failure. The clamp(s) (612) may be made from durable materials to withstand the elements and provide long-term stability.

The splice tray (620) is a flat, organized surface within the splice compartment where fiber optic splicing occurs. The splice tray (620) may include features such as slots or guides to hold fibers in place during the splicing process.

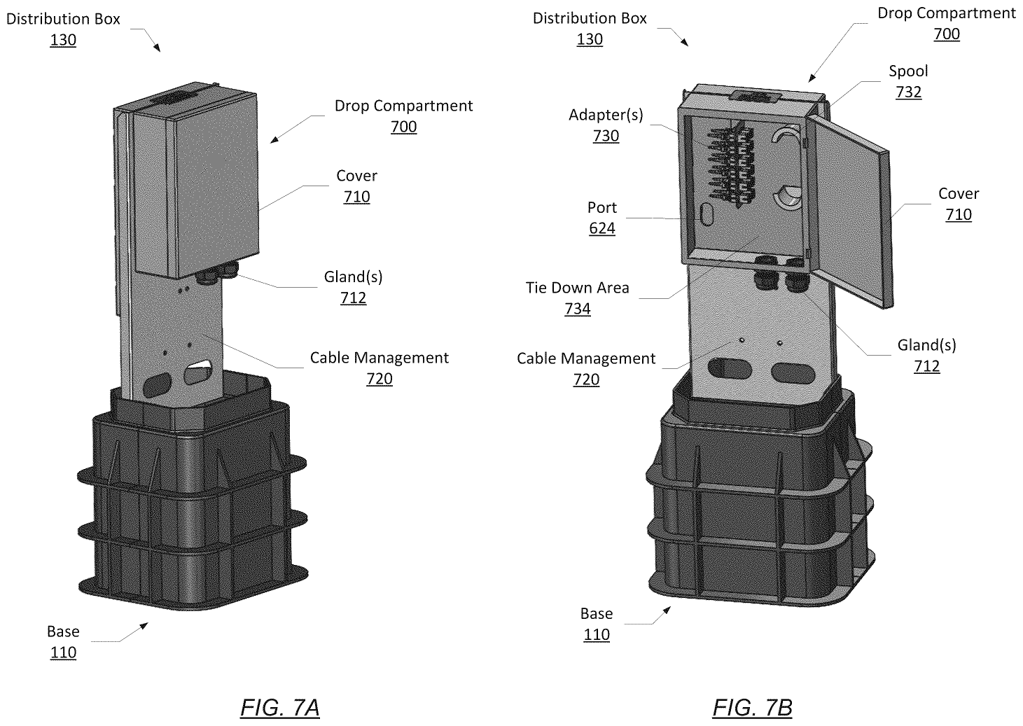

FIGS. 7A and 7B illustrate a drop side of the distribution box (130) when the pedestal (100) is in the second configuration (220). the distribution box (130) is shown with a cover (710) shown in both a closed configuration (FIG. 7A) and an open configuration (FIG. 7B).

The drop compartment (700) is a designated section within the distribution box for managing drop fibers. The drop compartment (700) provides an organized space for drop cable connections. The drop compartment (700) may include cable management features to maintain arrangement of the drop fibers oh.

The cover (710) protects the internal components of the drop compartment from environmental elements such as dust, moisture, and physical damage. The cover (710) may be a hinged panel that can be securely closed to seal the compartment or opened to provide access for maintenance and installation.

Gland(s) (712) are entry points for the drop cables into the distribution box. The gland(s) (712) provide strain relief and environmental sealing, preventing moisture and dust ingress, which could otherwise cause damage or connection failure. A cable management (720) system within the drop compartment may includes features such as tie-down areas and spools to organize and protect the drop fibers.

The adapter(s) (730) are connection points for the drop fibers within the distribution box. The adapter(s) (730) may be SC/APC type adapters, providing low insertion loss and high return loss, although other adapter types may also be used.

The port (624) serves as an entry or exit point for the fibers, allowing fibers to pass between the splice compartment (600) and the drop compartment (700). In some embodiments, fiber connections may be factory pre-installed from the splice tray (620) in the splice compartment (600) to the adapter(s) (730) in the drop compartment (700).

While FIGS. 1-7 shows a configuration of components, other configurations may be used without departing from the scope of the one or more embodiments. For example, various components may be combined to create a single component. As another example, the functionality performed by a single component may be performed by two or more components.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

The figures show diagrams of embodiments that are in accordance with the disclosure. The embodiments of the figures may be combined and may include or be included within the features and embodiments described in the other figures of the application. The features and elements of the figures are, individually and as a combination, improvements to the technology of fiber pedestals. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description. Further, other embodiments not explicitly described above can be devised which do not depart from the scope of the one or more embodiments as disclosed herein. Accordingly, the scope of the one or more embodiments should be limited only by the attached claims.

What is claimed is:

1. A fiber pedestal, comprising:
a base;
a cover; and
a distribution box;
wherein the base, the cover, and the distribution box structured to form first configuration and a second configuration,
the first configuration has a first volume and corresponds to an unassembled state of the fiber pedestal; and
the second configuration has a second volume that is larger than the first volume and corresponds to an assembled state of the fiber pedestal.

2. The fiber pedestal of claim 1, wherein the base includes a plurality of knockouts for selectively creating cable entry points.

3. The fiber pedestal of claim 1, wherein the distribution box includes a splice compartment with a pivotable splice tray.

4. The fiber pedestal of claim 1, wherein the cover includes a top cover member and two side cover members.

5. The fiber pedestal of claim 4, wherein the two side cover members are substantially identical parts.

6. The fiber pedestal of claim 1, wherein the distribution box includes trunk cable strain relief clamps.

7. The fiber pedestal of claim 1, wherein the base and cover are made from weather-resistant materials suitable.

8. The fiber pedestal of claim 1, wherein the distribution box includes ports for both incoming and outgoing fiber connections.

9. The fiber pedestal of claim 1, wherein the distribution box includes a drop compartment with SC/APC adapters.

10. The fiber pedestal of claim 1, wherein the distribution box includes a tie-down area.

11. The fiber pedestal of claim 1, wherein the distribution box includes a cable management system with spools.

12. A fiber pedestal, comprising:
a base having a rectangular configuration;
a cover, engageable with the base to define an interior space; and
a distribution box housed within the interior space;
wherein the base, the cover, and the distribution box are structured to form a first configuration and a second configuration,
the first configuration corresponds to an unassembled, nested state of the fiber pedestal, and
the second configuration corresponds to an assembled state of the fiber pedestal.

13. The fiber pedestal of claim 12, wherein the base includes a plurality of knockouts for selectively creating cable entry points.

14. The fiber pedestal of claim 12, wherein the distribution box includes a splice compartment with a pivotable splice tray.

15. The fiber pedestal of claim 12, wherein the cover includes a top cover member and two side cover members.

16. The fiber pedestal of claim 15, wherein the two side cover members are substantially identical parts.

17. The fiber pedestal of claim 12, wherein the distribution box includes trunk cable strain relief clamps.

18. The fiber pedestal of claim 12, wherein the distribution box includes ports for both incoming and outgoing fiber connections.

19. The fiber pedestal of claim 12, wherein the distribution box includes a drop compartment with SC/APC adapters.

20. A fiber pedestal, comprising:
a base with a split configuration allowing for the front and rear housing sections to be selectively assembled and separated;
a cover that that is engageable with the base; and
a distribution box positioned within the base and cover, the distribution box having a splice tray and a drop fiber management system,
wherein the base, the cover, and the distribution box are structured to form a first configuration and a second configuration,
the first configuration has a first volume for an unassembled, nested state of the fiber pedestal, and
the second configuration has a second volume larger than the first volume, corresponding to an operational, assembled state of the fiber pedestal.
